(19) United States
(12) Patent Application Publication
(10) Pub. No.: US 2019/0297904 A1
(43) Pub. Date: Oct. 3, 2019

(54) WATER-COOLED FILLET TABLE

(71) Applicant: Michael Poidomani, Freeport, NY (US)

(72) Inventor: Michael Poidomani, Freeport, NY (US)

(21) Appl. No.: 16/367,453

(22) Filed: Mar. 28, 2019

Related U.S. Application Data
(60) Provisional application No. 62/649,254, filed on Mar. 28, 2018.

(51) Int. Cl. A22C 25/06; B63B 29/04

(52) U.S. Cl. CPC A22C 25/06; B63B 2029/046; B63B 29/04

(57) ABSTRACT

A water-cooled fillet table includes a fillet table base. A plurality of interconnected grooves are formed in the fillet table base. The plurality of interconnected groves are positioned below an upper surface of the fillet table base and above a bottom surface of the fillet table base. An inlet is positioned in the fillet table base. The inlet is coupled to a first end of the plurality of interconnected grooves. An outlet is positioned in the fillet table base. The outlet is coupled to a second end of the plurality of interconnected grooves.

### CROSS-REFERENCE TO RELATED APPLICATION

This U.S. Non-Provisional Patent Application claims priority to U.S. Provisional Patent Application No. 62/649,254, filed on Mar. 28, 2018, the disclosure of which is incorporated by reference herein in its entirety.

### TECHNICAL FIELD

The present disclosure relates to a fillet table, and more particularly, exemplary embodiments of the present disclosure relate to a water-cooled fillet table.

### BACKGROUND

Fish fillets and fishing bait are sensitive to sun and heat exposure. For example, fishing bait left out in the sun or exposed to high temperature may quickly become dried out and its effectiveness at catching fish may be correspondingly reduced. As an example, fishing bait (e.g., clam or clam bellies) may be cut into smaller portions on a fillet or bait table prior to being used for fishing. However, the fishing bait may be exposed to the high temperatures and direct sunlight during this process and thus the smaller portions of fishing bait may be less effective at catching fish than fresh bait that has not been exposed to high temperatures or direct sunlight.

Fillet tables may be used to clean or fillet fish for later consumption. However, similar to fishing bait, fishing fillets exposed to high temperatures or direct sunlight, particularly on hot days, may become dried out. Thus, the quality of fish fillets may be reduced. For example, some varieties of fish are relatively expensive to purchase at market, and consumers may be highly sensitive to the quality of fish fillets purchased, particularly when such fillets are a delicacy or relatively high prices are charged. A reduction in the quality of fish fillets through exposure to high temperatures or direct sunlight may result in a decrease in the value of such fish fillets at market. Thus, keeping fish fillets at the lowest possible temperature during preparation may be desirable to maintain the highest possible consumption quality of such fish fillets.

### SUMMARY

According to an exemplary embodiment of the present disclosure, a water-cooled fillet table includes a fillet table base. A plurality of interconnected grooves are formed in the fillet table base. The plurality of interconnect groves are positioned below an upper surface of the fillet table base and above a bottom surface of the fillet table base. An inlet is positioned in the fillet table base. The inlet is coupled to a first end of the plurality of interconnected grooves. An outlet is positioned in the fillet table base. The outlet is coupled to a second end of the plurality of interconnected grooves.

According to an exemplary embodiment of the present disclosure, the inlet may be coupled to a hose connected with a pump configured to pass water through the plurality of interconnected grooves.

According to an exemplary embodiment of the present disclosure, a hose nozzle may be connected with the inlet by a hose.

According to an exemplary embodiment of the present disclosure, the water-cooled fillet table may include a bypass configured to direct incoming water to one of the hose nozzle or the plurality of interconnected grooves.

According to an exemplary embodiment of the present disclosure, the inlet may be coupled to a hose connected with a pump configured to pass water through the plurality of interconnected grooves. The hose may pass through a bucket configured to cool the water before the water is passed through the plurality of interconnected grooves.

According to an exemplary embodiment of the present disclosure, the fillet table base may be formed of high-density polyethylene (HDPE) or polyethylene high-density (PEHD).

According to an exemplary embodiment of the present disclosure, the inlet may be coupled to a hose configured to be connected with a pump integrated with a boat.

According to an exemplary embodiment of the present disclosure, the water-cooled fillet table may include a thermometer disposed in the fillet table base.

According to an exemplary embodiment of the present disclosure, a side surface of the thermometer may be adjacent to at least one groove of the plurality of interconnected grooves. An upper surface of the thermometer may be substantially coplanar with the upper surface of the fillet table base.

According to an exemplary embodiment of the present disclosure, the bottom surface of the fillet table base may be coupled to a support arm.

According to an exemplary embodiment of the present disclosure, the support arm may include a quick-release mechanism configured to separate the fillet table base from the support arm.

According to an exemplary embodiment of the present disclosure, a water-cooled fillet table includes a fillet table base. A plurality of interconnected grooves are formed in the fillet table base. The plurality of interconnected groves are positioned below an upper surface of the fillet table base and above a bottom surface of the fillet table base. The plurality of interconnected grooves are configured to pass water through an interior of the fillet table base. An inlet is positioned in the fillet table base. The inlet is coupled to a first end of the plurality of interconnected grooves. The inlet is coupled to a first hose connected with a pump. An outlet is positioned in the fillet table base. The outlet is coupled to a second end of the plurality of interconnected grooves. The outlet is coupled to a second hose.

According to an exemplary embodiment of the present disclosure, the water-cooled fillet table may include a hose nozzle connected with the inlet by a bypass groove spaced apart from the plurality of interconnected grooves.

According to an exemplary embodiment of the present disclosure, the water-cooled fillet table may include a bypass button configured to direct incoming water to one of the bypass groove or the plurality of interconnected grooves.

According to an exemplary embodiment of the present disclosure, the first hose may pass through a bucket configured to cool the water before the water is passed through the plurality of interconnected grooves.

### BRIEF DESCRIPTION OF THE FIGURES

The above and other features of the present disclosure will become more apparent by describing in detail exemplary embodiments thereof, with reference to the accompanying drawings, in which:

FIG. 1 illustrates a schematic diagram of a water-cooled fillet table according to an exemplary embodiment of the present disclosure.

FIG. 2 illustrates an example of a path of water through a water-cooled fillet table according to an exemplary embodiment of the present disclosure.

FIG. 3A illustrates an upper surface of a water-cooled fillet table according to an exemplary embodiment of the present disclosure.

FIG. 3B illustrates an interior of a water-cooled fillet table including a plurality of interconnected grooves according to an exemplary embodiment of the present disclosure.

FIG. 4 illustrates a side view of a water-cooled fillet table according to an exemplary embodiment of the present disclosure.

FIG. 5 illustrates a bottom view of a water-cooled fillet table according to an exemplary embodiment of the present disclosure.

FIG. 6 illustrates a support arm of a water-cooled fillet table according to an exemplary embodiment of the present disclosure.

FIG. 7 is a schematic diagram of a water-cooled fillet table according to an exemplary embodiment of the present disclosure.

FIG. 8 is a cross sectional view of the water-cooled fillet table of FIG. 7.

FIG. 9 illustrates an example of a flow of water along a top surface of the water-cooled fillet table of FIG. 7.

### DETAILED DESCRIPTION

It will be understood that the terms “first,” “second,” “third,” etc. are used herein to distinguish one element from another, and the elements are not limited by these terms. Thus, a “first” element in an exemplary embodiment may be described as a “second” element in another exemplary embodiment.

Exemplary embodiments of the present disclosure will be described more fully hereinafter with reference to the accompanying drawings. Like reference numerals may refer to like elements throughout the specification and drawings.

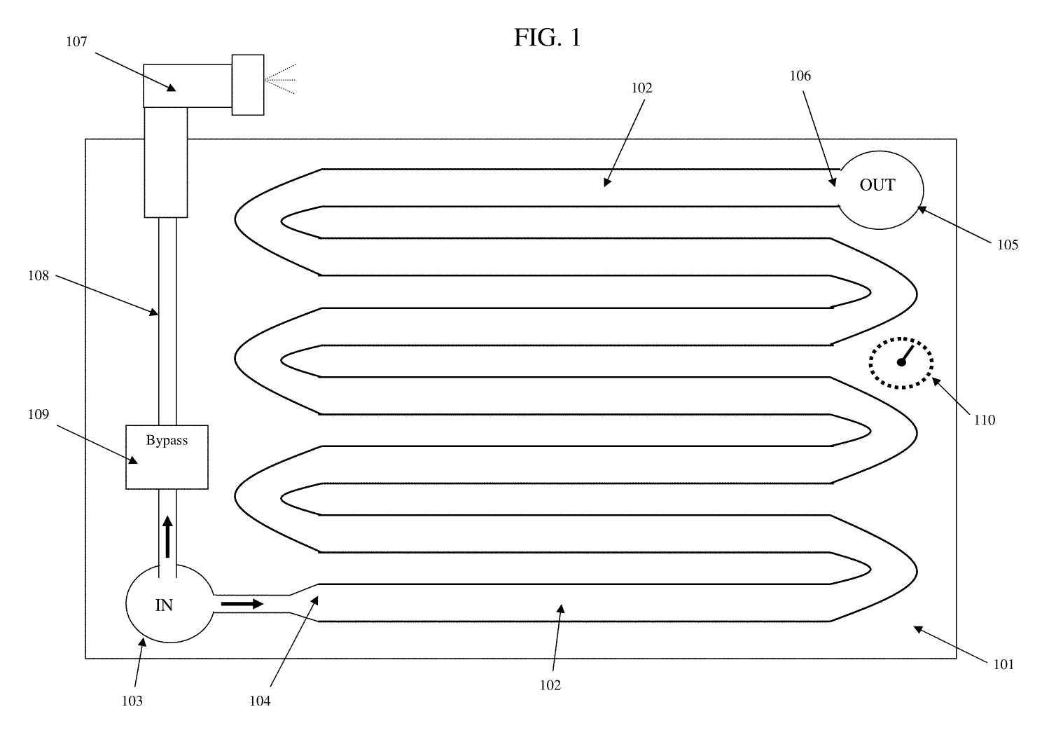

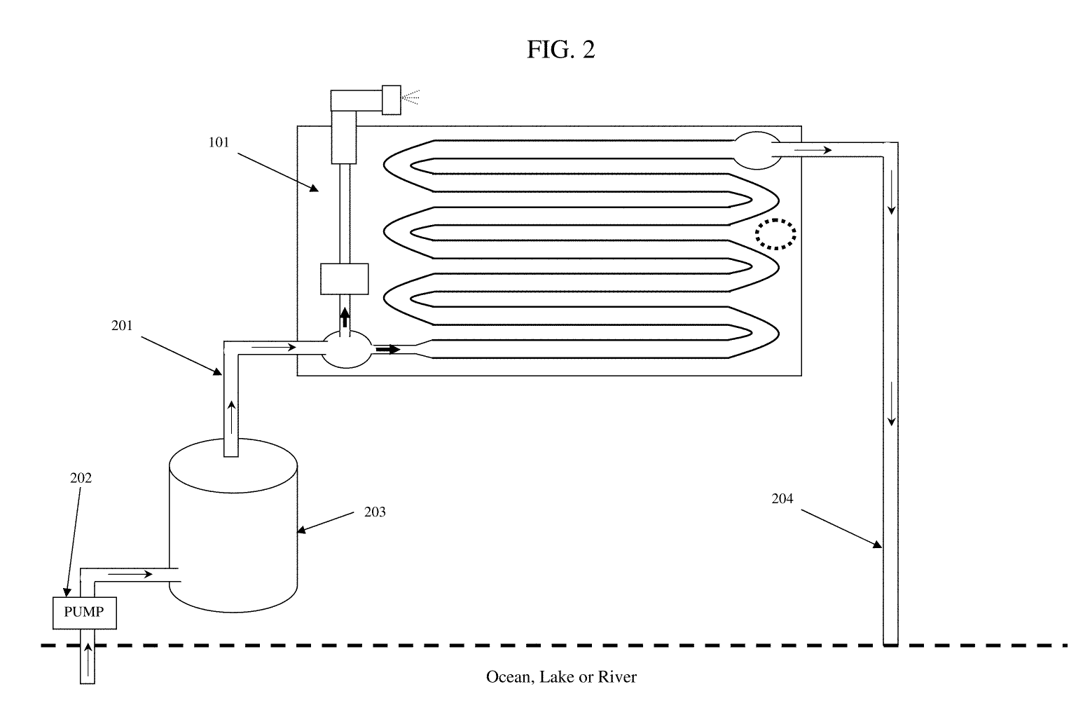

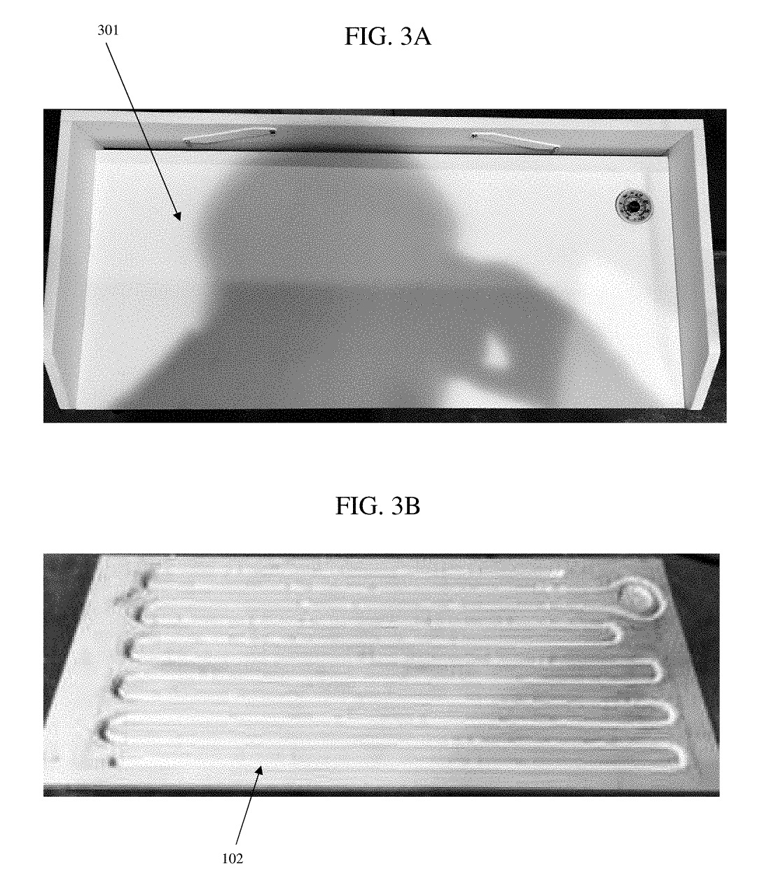

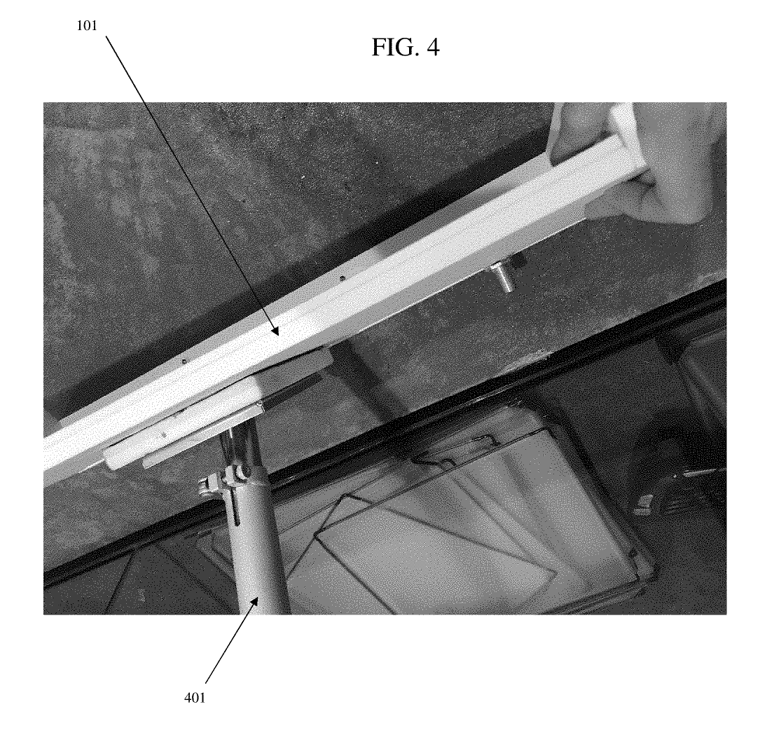

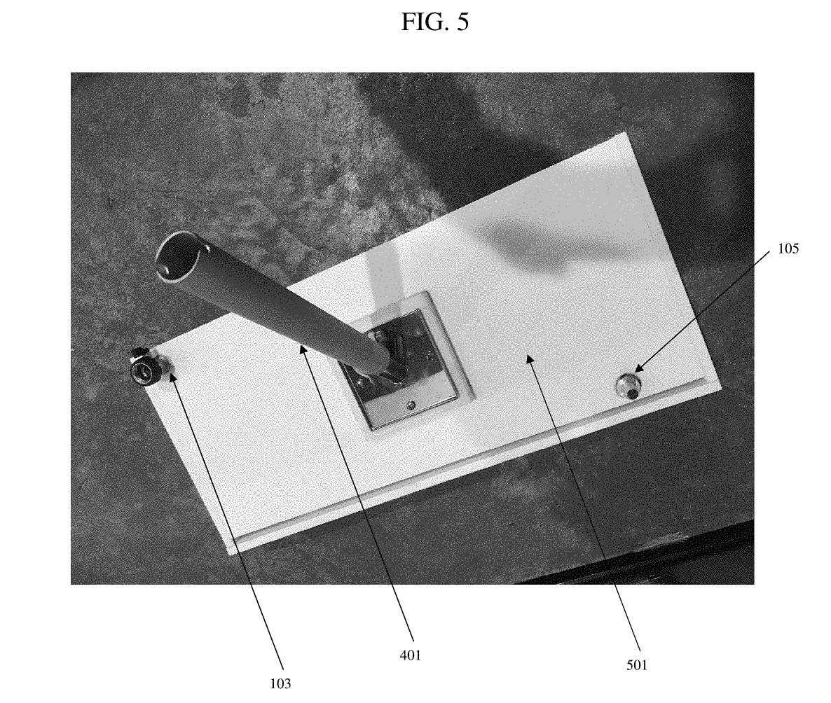

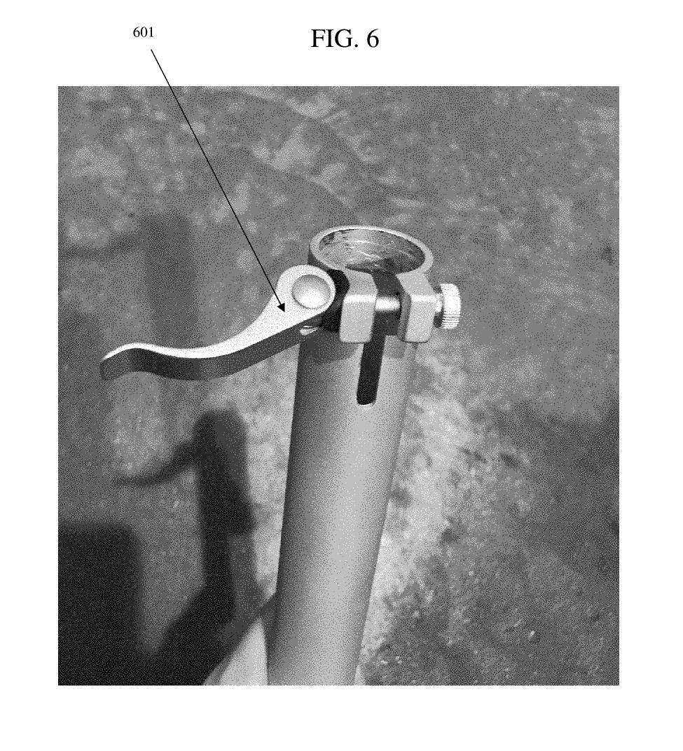

FIG. 1 illustrates a schematic diagram of a water-cooled fillet table according to an exemplary embodiment of the present disclosure. FIG. 2 illustrates an example of a path of water through a water-cooled fillet table according to an exemplary embodiment of the present disclosure. FIG. 3A illustrates an upper surface of a water-cooled fillet table according to an exemplary embodiment of the present disclosure. FIG. 3B illustrates an interior of a water-cooled fillet table including a plurality of interconnected grooves according to an exemplary embodiment of the present disclosure. FIG. 4 illustrates a side view of a water-cooled fillet table according to an exemplary embodiment of the present disclosure. FIG. 5 illustrates a bottom view of a water-cooled fillet table according to an exemplary embodiment of the present disclosure. FIG. 6 illustrates a support arm of a water-cooled fillet table according to an exemplary embodiment of the present disclosure.

Referring to FIGS. 1, 2, 3A, 3B and 4-6, according to an exemplary embodiment of the present disclosure, a water-cooled fillet table includes a fillet table base 101. A plurality of interconnected grooves 102 are formed in the fillet table base 101. The plurality of interconnected groves 102 are positioned below an upper surface 301 of the fillet table base 101 and above a bottom surface 501 of the fillet table base 101. An inlet 103 is positioned in the fillet table base 101. The inlet 103 is coupled to a first end 104 of the plurality of interconnected grooves 102. An outlet 105 is positioned in the fillet table base 101. The outlet 105 is coupled to a second end 106 of the plurality of interconnected grooves 102.

According to an exemplary embodiment of the present disclosure, the inlet 103 may be coupled to a hose 201 connected with a pump 202 configured to pass water through the plurality of interconnected grooves 102. The hose 201 may be connected with a pump that is integrated within a boat. For example, the hose 201 may connect with a raw water wash down connection built into a boat. Alternatively, the hose 201 may be connected with an autonomous pump that operates independently of a boat. The autonomous pump may be positioned on a boat, dock or other desired location, and may be configured to pump water from a body of water such as an ocean, bay, inlet, lake or river through the inlet 103 and into the plurality of interconnected grooves 102. After the water is circulated (e.g., passed) through the plurality of interconnected grooves 102, the water may exit the outlet 105. Thus, the water having passed through the plurality of interconnected grooves 102 may be directed out of the outlet 105 and back into the body of water it originated from (e.g., through a hose 204 connected with the outlet 105).

According to an exemplary embodiment of the present disclosure, a hose nozzle 107 may be connected with the inlet 103 by a hose 108. The fillet table may additionally include a faucet, which may be connected with the hose 108 and may include an independent bypass or an independent on/off valve to activate the faucet. The hose 108 may include a first portion disposed within the fillet table base 101 similar to the plurality of interconnect groves 102, and a second portion (e.g., a retractable or self-coiling exterior hose) outside the fillet table base 101 which allows the hose nozzle 107 to be moved around the fillet table. For example, the second portion of the hose 108 may have a reach of from about 3 ft to about 10 ft with respect to the first portion of the hose 108.

According to an exemplary embodiment of the present disclosure, the water-cooled fillet table may include a bypass 109 configured to direct incoming water to one of the hose nozzle 107 or the plurality of interconnected grooves 102. The bypass 109 may be a button which temporarily diverts water from the plurality of interconnected groves 102 to the hose 108 to activate the hose nozzle 107. Thus, the hose nozzle 107 may be turned on for a relatively short period of time (e.g., to was down the fillet table) while the bypass is activated (e.g., the button is pushed). The default position of the bypass 109 may be to divert cooling water arriving through the inlet 103 to the plurality of interconnect groves 102. Thus, the bypass 109 may automatically return to a default position after the hose nozzle 107 has been used.

According to an exemplary embodiment of the present disclosure, the inlet 103 may be coupled to a hose 201 connected with a pump 202 configured to pass water through the plurality of interconnected grooves 102. The hose 201 may pass through a bucket 203 configured to cool the water before the water is passed through the plurality of interconnected grooves 102. The bucket 203 may include a hose or pipe (e.g., a part of hose 201) coiled around the inside of the bucket. Thus, the bucket may be filled with ice, ice and water or a salt water/ice slurry to cool water passing through the hose or pipe within the bucket 203. The hose or pipe within the bucket may be formed of a same material as the hose 201 outside the pipe, or may be formed of a different material. For example, the hose or pipe within the bucket may be formed of a metal (e.g., copper or brass) configured to maximally reduce the temperature of the water passing through the inside of the hose or pipe within the bucket 203. The hose or pipe being coiled or arranged within the bucket may be shaped and positioned to maximize surface area between the ice, ice and water or a salt water/ice slurry to cool water passing through the hose or pipe within the bucket 203. Thus, the water passing through the plurality of interconnect groves 102 may maximally reduce the temperature of the fillet table base 101 of the fillet table. For example, Applicant has determined that the surface temperature of the fillet table base 101 may be reduced by as much as 30 to 40 degrees Fahrenheit.

According to an exemplary embodiment of the present disclosure, the fillet table base 101 may be formed of high-density polyethylene (HDPE) or polyethylene high-density (PEHD).

According to an exemplary embodiment of the present disclosure, the inlet 103 may be coupled to a hose 202 configured to be connected with a pump integrated with a boat.

According to an exemplary embodiment of the present disclosure, the water-cooled fillet table may include a thermometer 110 disposed in the fillet table base. According to an exemplary embodiment of the present disclosure, a side surface of the thermometer 110 may be adjacent to at least one groove of the plurality of interconnected grooves 102. An upper surface of the thermometer 110 may be substantially coplanar with the upper surface 301 of the fillet table base 101. Thus, the thermometer may be used to monitor a surface temperature of the fillet table base 101.

According to an exemplary embodiment of the present disclosure, the bottom surface 501 of the fillet table base 101 may be coupled to a support arm 401.

According to an exemplary embodiment of the present disclosure, the support arm 401 may include a quick-release mechanism 601 configured to separate the fillet table base 101 from the support arm 401. Thus, the fillet table base 101 may be separated from the support arm 401. As an example, the fillet table base 101 may be decoupled from the support arm 401 positioned on a boat (e.g., in a rod holder) and transferred to another support arm positioned on a dock, thus allowing the fillet table base 101 to be easily moved between locations. The support arm 401 is illustrated as a single support arm; however two support arms may be provided, which may allow secure attachment of the fillet tablet based to, for example, two rod holders on a boat. The distance between the support arms 401 when two or more support arms are provided may be adjustable to accommodate different boat and dock configurations (e.g., different widths between adjacent rod holders). The support arm 401 may include a locking groove configured to securely connect the support arm 401 to a cross pin at a bottom of a rod holder.

According to an exemplary embodiment of the present disclosure, a water-cooled fillet table includes a fillet table base 101. A plurality of interconnected grooves 102 are formed in the fillet table base 101. The plurality of interconnect groves 102 are positioned below an upper surface 301 of the fillet table base 101 and above a bottom surface 501 of the fillet table base 101. The plurality of interconnected grooves 102 are configured to pass water through an interior of the fillet table base 101. An inlet 103 is positioned in the fillet table base 101. The inlet 103 is coupled to a first end 104 of the plurality of interconnected grooves 102. The inlet 103 is coupled to a first hose 201 connected with a pump 202. An outlet 105 is positioned in the fillet table base 101. The outlet 105 is coupled to a second end 106 of the plurality of interconnected grooves 102. The outlet 105 is coupled to a second hose 204.

According to an exemplary embodiment of the present disclosure, the water-cooled fillet table may include a hose nozzle 107 connected with the inlet 103 by a bypass groove 108 spaced apart from the plurality of interconnected grooves 102.

According to an exemplary embodiment of the present disclosure, the water-cooled fillet table may include a bypass button 109 configured to direct incoming water to one of the bypass groove 108 or the plurality of interconnected grooves 102.

According to an exemplary embodiment of the present disclosure, the fillet table base 101 may be formed of a single continuous sheet or plank of material. Alternatively, the fillet table base 101 may include a first portion and a second portion disposed on the first portion (see, e.g., FIG. 4). The plurality of interconnected groves 102 may be formed in the first portion and the second portion may be disposed over the top of the plurality of interconnect groves 102 to seal the plurality of interconnected groves 102. The first and second portions may be sealed together using an adhesive. For example, the adhesive may be a marine rated adhesive sealant.

The fillet table base 101 as well as vertical walls of the fillet table may be formed of Marine Lumber, which is high-density polyethylene that is stabilized to resist saltwater, chemicals, and sunlight. It will not rot or delaminate and is easily cut, routed, shaped and drilled, using standard woodworking tools. It retains its original color indefinitely, and doesn't require refinishing. The scuff-resistant surface cleans easily and quickly with a scrub brush and light abrasive cleaner. It may have a matte surface texture. Marine Lumber may be formed of High-density polyethylene (HDPE) or polyethylene high-density (PEHD), which is a polyethylene thermoplastic made from petroleum. It is sometimes called “alkathene” or “polythene.”

According to an exemplary embodiment of the present disclosure, the fillet table may include a built in ruler. For example, a ruler may be coupled to the fillet table base 101. Alternatively, measurement lines may be etched into the fillet table base 101.

According to an exemplary embodiment of the present disclosure, the fillet table may include slots to hold knives (see, e.g., FIG. 3A). Two knife holders are illustrated; however, exemplary embodiments of the present disclosure are not limited thereto, and the number or position of knife slots may be adjusted, as desired.

According to an exemplary embodiment of the present disclosure, the fillet table may be customizable to be any desired size (e.g., to be used for relatively small or relatively large game fish or to be used for different size boats, docks, or other spaces). Additionally, the length, arrangement and number of the plurality of interconnected grooves 102 may be adjusted and customized, as desired.

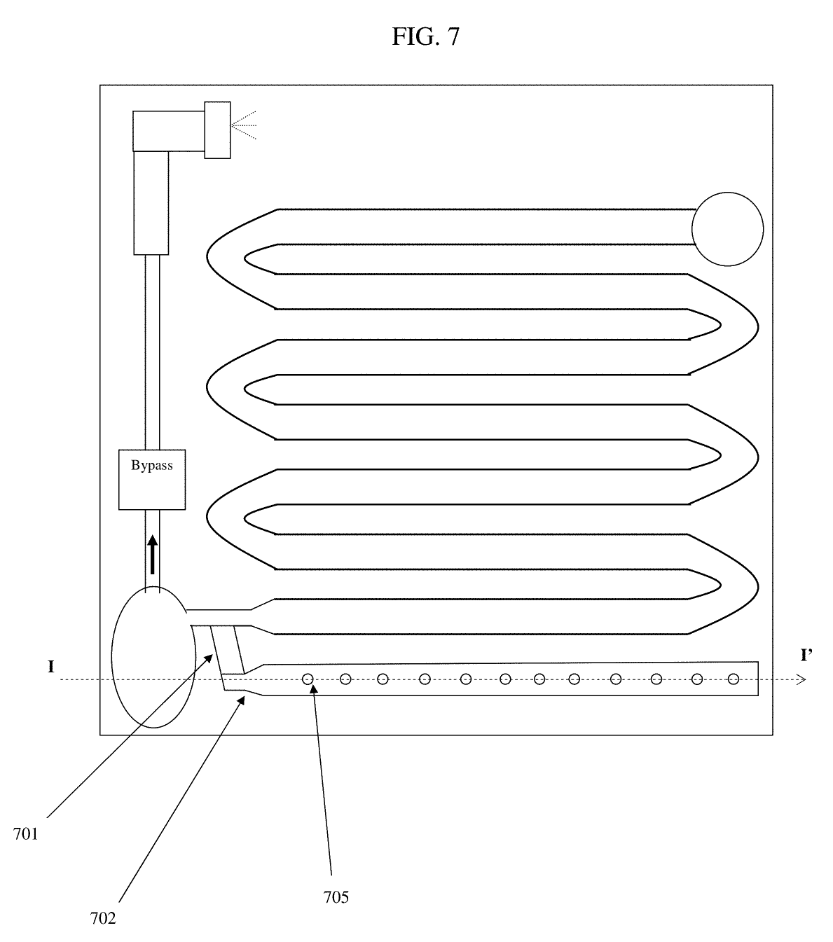

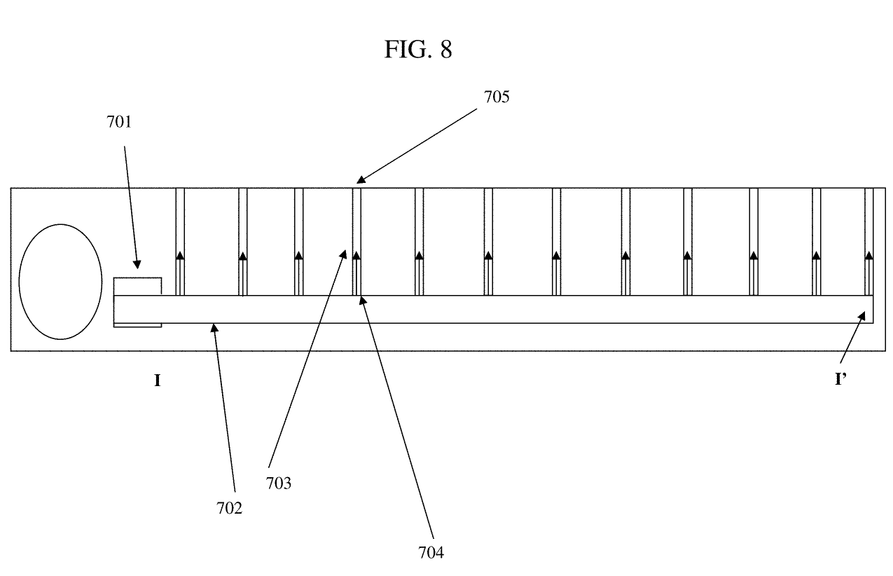

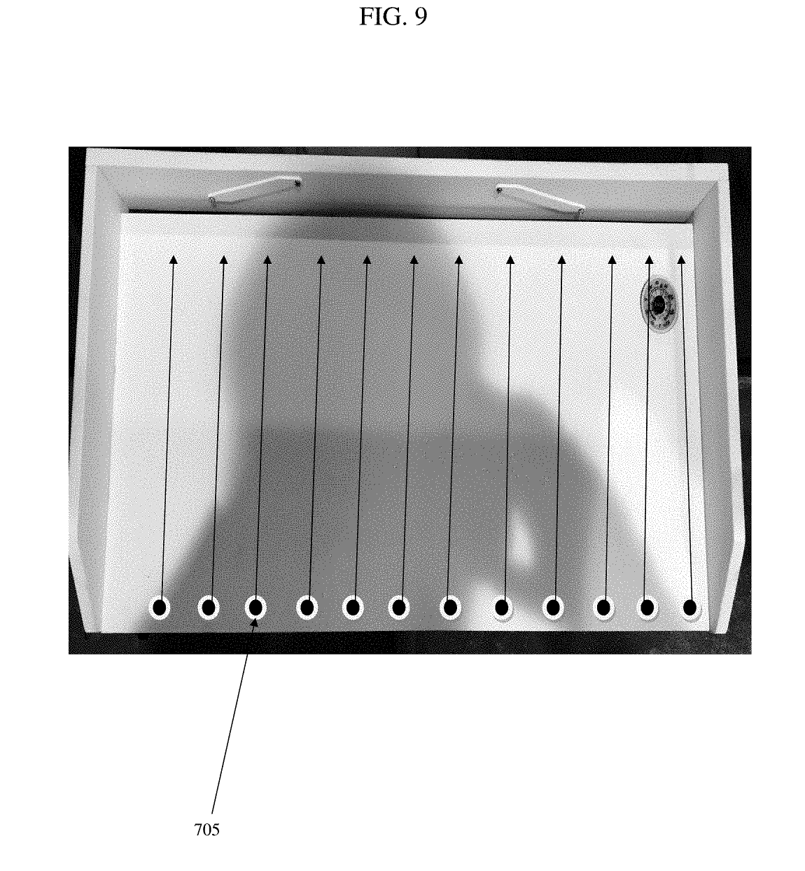

FIG. 7 is a schematic diagram of a water-cooled fillet table according to an exemplary embodiment of the present disclosure. FIG. 8 is a cross sectional view of the water-cooled fillet table of FIG. 7. FIG. 9 illustrates an example of a flow of water along a top surface of the water-cooled fillet table of FIG. 7.

Referring to FIGS. 7-9, according to an exemplary embodiment of the present disclosure a water-cooled fillet table includes a fillet table base 101. A plurality of interconnected grooves 102 are formed in the fillet table base 101. The plurality of interconnected groves 102 are positioned below an upper surface 301 of the fillet table base 101 and above a bottom surface 501 of the fillet table base 101. An inlet 103 is positioned in the fillet table base 101. The inlet 103 is coupled to a first end 104 of the plurality of interconnected grooves 102. An outlet 105 is positioned in the fillet table base 101. The outlet 105 is coupled to a second end 106 of the plurality of interconnected grooves 102. A channel 702 is connected to the plurality of interconnected grooves 102. The channel 702 includes a plurality of holes 703. Each of the holes of the plurality of holes 703 includes a first end 704 connected with the channel 702 and a second end 705 open to the upper surface 301 of the fillet table base 101

According to an exemplary embodiment of the present disclosure, a diverter 701 may be positioned between the channel 702 and the plurality of interconnected grooves 102. The diverter 701 may be used to direct water through the channel 702, through the holes 703 and onto the upper surface 301 of the fillet table base 101. The water may flow toward a back side of the fillet table base 101 (see, e.g., FIG. 9) and may pass through a gap formed at the back side of the fillet table base 101. Thus, the flow of water may be used to further cool the upper surface 301 of the fillet table base 101. Additionally, the flow of water may be used to clear debris, bait, or other objects from the upper surface 301 of the fillet table base 101.

According to an exemplary embodiment of the present disclosure, the diverter 701 may be operated by a manual adjustment part (e.g., a manually operated button) exposed to the upper surface 301 of the fillet table base 101.

According to an exemplary embodiment of the present disclosure, the diverter 701 may be electrically operated. The diverter 701 may be configured to receive either a first input that corresponds to directing incoming water to the plurality of interconnected grooves 102 or a second input that directs incoming water to the plurality of holes 703.

According to an exemplary embodiment of the present disclosure, the second end 705 of each of the holes 703 may be coupled to a spray nozzle suspended on or over the upper surface 301 of the fillet table base 101.

Having described exemplary embodiments of the present disclosure, it is further noted that it is readily apparent to those of ordinary skill in the art that various modifications may be made without departing from the spirit and scope of the present disclosure.

What is claimed is:

1. A water-cooled fillet table, comprising:
a fillet table base;
a plurality of interconnected grooves formed in the fillet table base, wherein the plurality of interconnect groves are positioned below an upper surface of the fillet table base and above a bottom surface of the fillet table base;
an inlet positioned in the fillet table base, wherein the inlet is coupled to a first end of the plurality of interconnected grooves; and
an outlet positioned in the fillet table base, wherein the outlet is coupled to a second end of the plurality of interconnected grooves.

2. The water-cooled fillet table of claim 1, wherein the inlet is coupled to a hose connected with a pump configured to pass water through the plurality of interconnected grooves.

3. The water-cooled fillet table of claim 1, further comprising a hose nozzle connected with the inlet by a hose.

4. The water-cooled fillet table of claim 3, further comprising a bypass configured to direct incoming water to one of the hose nozzle or the plurality of interconnected grooves.

5. The water-cooled fillet table of claim 1, wherein the inlet is coupled to a hose connected with a pump configured to pass water through the plurality of interconnected grooves, and wherein the hose passes through a bucket configured to cool the water before the water is passed through the plurality of interconnected grooves.

6. The water-cooled fillet table of claim 1, wherein the fillet table base is formed of high-density polyethylene (HDPE) or polyethylene high-density (PEHD).

7. The water-cooled fillet table of claim 1, wherein the inlet is coupled to a hose configured to be connected with a pump integrated with a boat.

8. The water-cooled fillet table of claim 1, further comprising a thermometer disposed in the fillet table base.

9. The water-cooled fillet table of claim 8, wherein a side surface of the thermometer is adjacent to at least one groove of the plurality of interconnected grooves, and wherein an upper surface of the thermometer is substantially coplanar with the upper surface of the fillet table base.

10. The water-cooled fillet table of claim 1, wherein the bottom surface of the fillet table base is coupled to a support arm.

11. The water-cooled fillet table of claim 10, wherein the support arm includes a quick-release mechanism configured to separate the fillet table base from the support arm.

12. A water-cooled fillet table, comprising:
a fillet table base;
a plurality of interconnected grooves formed in the fillet table base, wherein the plurality of interconnect groves are positioned below an upper surface of the fillet table base and above a bottom surface of the fillet table base, and wherein the plurality of interconnected grooves are configured to pass water through an interior of the fillet table base;
an inlet positioned in the fillet table base, wherein the inlet is coupled to a first end of the plurality of interconnected grooves, and wherein the inlet is coupled to a first hose connected with a pump; and
an outlet positioned in the fillet table base, wherein the outlet is coupled to a second end of the plurality of interconnected grooves, and wherein the outlet is coupled to a second hose.

13. The water-cooled fillet table of claim 12, further comprising a hose nozzle connected with the inlet by a bypass groove spaced apart from the plurality of interconnected grooves.

14. The water-cooled fillet table of claim 13, further comprising a bypass button configured to direct incoming water to one of the bypass groove or the plurality of interconnected grooves.

15. The water-cooled fillet table of claim 12, wherein the fillet table base is formed of high-density polyethylene (HDPE) or polyethylene high-density (PEHD).

16. The water-cooled fillet table of claim 12, further comprising a thermometer disposed in the fillet table base.

17. The water-cooled fillet table of claim 16, wherein a side surface of the thermometer is adjacent to at least one groove of the plurality of interconnected grooves, and wherein an upper surface of the thermometer is substantially coplanar with the upper surface of the fillet table base.

18. The water-cooled fillet table of claim 12, wherein the bottom surface of the fillet table base is coupled to a support arm.

19. The water-cooled fillet table of claim 18, wherein the support arm includes a quick-release mechanism configured to separate the fillet table base from the support arm.

20. The water-cooled fillet table of claim 12, wherein the first hose passes through a bucket configured to cool the water before the water is passed through the plurality of interconnected grooves.
